(19) United States
(12) Patent Application Publication
(10) Pub. No.: US 2008/0057367 A1
(43) Pub. Date: Mar. 6, 2008

(54) FUEL CELL SYSTEM

(75) Inventor: Toru Nakakubo, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/844,075

(22) Filed: Aug. 23, 2007

(30) Foreign Application Priority Data
Sep. 4, 2006 (JP) 2006-238996(PAT.)

(51) Int. Cl. H01M 8/02

(52) U.S. Cl. 429/26; 429/12

(57) ABSTRACT

There is provided a fuel cell system which does not require a sensor or a circuit, can prevent itself from being dried in a low humidity state and enhance air permeability in an excessively wet state, and can be reduced in size. The fuel cell system generates an electric power by supplying fuel to a fuel electrode while supplying outside air to an oxidizer electrode through an air hole, and includes a gas permeation mechanism including a member which has air permeability increased when absorbing moisture than when being dry, in a flow path through which the outside air supplied from the air hole flows.

### BACKGROUND OF THE INVENTION

1. Field of the Invention

The present invention relates to a fuel cell system, and in particular, relates to a fuel cell system including a small fuel cell, which has a gas permeation mechanism for controlling an air permeation rate in accordance with humidity inside the fuel cell.

2. Description of the Related Art

Hitherto, various types of fuel cells are researched and developed. Of those, a polymer electrolyte fuel cell (or proton exchange membrane fuel cell) is widely researched and developed as an automotive or residential power generation apparatus for the reasons that the operating temperature of the polymer electrolyte fuel cell is lower than that of other types of fuel cells, the electrolyte used therein is a polymer electrolyte membrane and can be easily handled, or the like. In the polymer electrolyte fuel cell, a polymer electrolyte membrane is used for the electrolyte, and power generation is performed by supplying, with respect to a membrane electrode assembly having catalyst electrode layers provided on the both sides of the polymer electrolyte membrane, a fuel such as hydrogen to one (anode) of the catalyst electrode layers, and supplying an oxidizer such as air to the other catalyst electrode layer (cathode). At that time, water is generated as a product. The reaction formulae in the anode and the cathode are as follows.

Anode: H₂→2H⁻+2e⁻

Cathode: ½ O₂+2H⁺+2e⁻→H₂O

The above described reaction in the cathode involves the production of water. When the produced water is not immediately removed from a cathode flow path, the produced water remarkably degrades the power generation characteristics due to a so-called flooding phenomenon in which the produced water blocks the flow path to hinder the supply of air to the cathode. On the other hand, protons generated in the anode move together with water through the polymer electrolyte membrane. Accordingly, when the polymer electrolyte membrane is dry, the power generation characteristics are remarkably degraded due to a so-called dry-out phenomenon in which the protons can not move to increase the internal resistance of the fuel cell. In order to prevent the phenomenon, it is necessary for the polymer electrolyte membrane to be kept wet. Specifically, the inside of a fuel cell system must not be too dry or too wet.

Japanese Patent Application Laid-Open No. 2004-192973 discloses a technology of controlling the flow rate of an inflow gas by measuring the temperatures, humidities and flow rates of the inflow gas and an outflow gas into and from a fuel cell system, and comparing them with an amount of produced water. Thereby, the fuel cell system controls the amount of water remaining in the fuel cell at a level suitable for a polymer electrolyte membrane.

On the other hand, a method shown in Japanese Patent Application Laid-Open No. 2000-218709 has been known as a method for passively controlling an air permeation rate in accordance with the state of surrounding water. This is a method in which a vent hole is formed by use of a laminate of films showing different swelling rates depending on water content, whereby the films are displaced depending on wet state to thereby adjust the air permeation rate.

In addition, Japanese Patent Application Laid-Open No. 2005-036374 discloses a textile fabric which has a loop structure composed of a water-absorbing self-extensible yarn and a non-self-extensible yarn, and improves air permeability in a wet state.

However, the method of controlling humidity in a fuel cell disclosed in Japanese Patent Application Laid-Open No. 2004-192973 requires a humidity sensor, a control circuit, and an air flow rate changing means. Accordingly, there is a fear that the system may increase in size and the power consumption of an auxiliary equipment may also increase, so that the method is not suitable for a small fuel cell in particular.

In addition, the method of controlling the air permeation rate in accordance with the water content in atmosphere as disclosed in Japanese Patent Application Laid-Open No. 2000-218709 is used mainly in a clothing material, is aimed at striking a balance between improvement of air permeability in a sweating state and improvement of heat retaining property in a normal state, and is not intended for use in the fuel cell system.

### SUMMARY OF THE INVENTION

The present invention is directed to a fuel cell system which does not require a sensor or a circuit, can prevent itself from being dried in a low humidity state and enhance air permeability in an excessively wet state, and can be reduced in size.

A fuel cell system according to the present invention is for generating an electric power by supplying fuel to a fuel electrode while supplying outside air to an oxidizer electrode through an air hole, and has a gas permeation mechanism that includes a member which increases air permeability when absorbing moisture than when being dry in a flow path through which the outside air supplied from the air hole flows.

The fuel cell system according to the present invention does not needs a sensor or a circuit, can prevent itself from being dried in a low humidity state, can enhance air permeability in an excessively wet state, and can be reduced in size.

Further features of the present invention will become apparent from the following description of exemplary embodiments with reference to the attached drawings.

### BRIEF DESCRIPTION OF THE DRAWINGS

FIG. 1 is a schematic perspective view illustrating a fuel cell system having a gas permeation mechanism according to Embodiment 1 in the present invention.

FIG. 2 is a schematic diagram illustrating a fuel cell system having a gas permeation mechanism according to Embodiment 1 of the present invention.

FIG. 3 is a schematic cross-sectional view illustrating a first form of a gas permeation mechanism according to Embodiment 1 of the present invention.

FIG. 4 is a schematic cross-sectional view illustrating a second form of a gas permeation mechanism according to Embodiment 1 of the present invention.

FIG. 5 is a schematic cross-sectional view illustrating a third form of a gas permeation mechanism according to Embodiment 1 of the present invention.

FIGS. 6A and 6B are schematic plan views illustrating the third form of the gas permeation mechanism according to Embodiment 1 of the present invention.

FIGS. 7A, 7B, 7C, and 7D are schematic cross-sectional views illustrating steps for producing the third form of the gas permeation mechanism according to Embodiment 1 of the present invention, by using a semiconductor processing technique.

FIG. 8A is photographs illustrating a dry state and a wet state of a gas permeation mechanism which employs a textile fabric including a polyether ester and a polyester used in the present invention. FIG. 8B is a graphical representation illustrating characteristics of air flow rate in a dry state and in a wet state in a gas permeation mechanism which employs a textile fabric including a polyether ester and a polyester, according to Embodiment 1 of the present invention.

FIG. 9 is a schematic cross-sectional view illustrating a fuel cell having a gas permeation mechanism according to Embodiment 1 of the present invention.

FIG. 10 is a schematic cross-sectional view illustrating a structural example having a water flow path provided between an oxidizer flow path and a gas permeation mechanism according to Embodiment 1 of the present invention.

FIG. 11 is a schematic cross-sectional view illustrating a structural example having a water retaining portion in a fuel cell having a gas permeation mechanism according to Embodiment 2 of the present invention.

FIG. 12 is a schematic cross-sectional view illustrating a structural example having a water flow path provided between a water retaining portion and a gas permeation mechanism according to Embodiment 2 of the present invention.

FIG. 13 is a schematic cross-sectional view illustrating a structural example having a radiating portion provided in a fuel cell having a gas permeation mechanism according to Embodiment 3 of the present invention.

FIG. 14 is a schematic cross-sectional view illustrating a structural example having a water flow path provided between a radiating portion and a gas permeation mechanism according to Embodiment 3 of the present invention.

FIG. 15 is a schematic cross-sectional view illustrating a structural example using a fuel tank accommodating a hydrogen storage alloy, in a fuel cell system having a gas permeation mechanism according to Embodiment 4 of the present invention.

FIG. 16 is a schematic cross-sectional view illustrating a structural example having a water flow path provided between a fuel tank and a gas permeation mechanism according to Embodiment 4 of the present invention.

FIG. 17 is a schematic perspective view illustrating a structural example using a fan for air intake according to Embodiment 5 of the present invention.

FIG. 18 is a schematic cross-sectional view illustrating a structural example having an upstream air hole disposed at an air inlet and a gas permeation mechanism disposed at a discharge port according to Embodiment 5 of the present invention.

FIG. 19 is a schematic cross-sectional view illustrating a structural example having a gas permeation mechanism disposed at an air inlet and a downstream air hole disposed at a discharge port, in the structural example using a fan for air intake according to Embodiment 6 of the present invention.

FIG. 20 is a schematic cross-sectional view illustrating a structural example having an opening which serves both as an air inlet and as a discharge port in the structural example using a fan for air intake according to Embodiment 7 of the present invention.

### DESCRIPTION OF THE EMBODIMENTS

Embodiments of the present invention will be now described in detail with reference to the attached drawings.

A fuel cell system according the present embodiment has a gas permeation mechanism and a water supply mechanism which collects water produced by power generation and supplies the water to the gas permeation mechanism. A gas permeation mechanism according to the present embodiment has a member which expands due to moisture absorption and is composed so as to increase the air permeation rate of the gas permeation mechanism due to the expansion.

The shape of the gas permeation mechanism which increases the air permeation rate by moisture absorption includes a textile fabric shape and a plate shape.

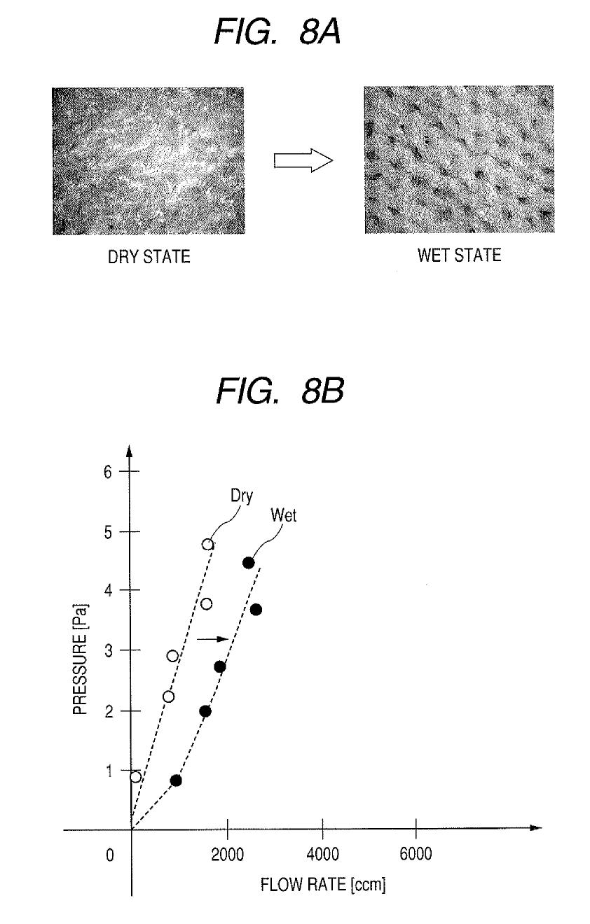

The gas permeation mechanism having the textile fabric shape includes a textile fabric including, for instance, fibers comprised of a material which extends when absorbing moisture, such as a polyether ester, and fibers comprised of a non-extending material such as a polyester. FIG. 8A is photographs illustrating a dry state and a wet state of an example of such a textile fabric including a polyether ester and a polyester. The textile fabric is a texture having a self-adjusting function manufactured by TEIJIN FIBERS LTD. and used in a sportswear Sphere REACT Cool (trade name; manufactured by NIKE Inc.). It can be seen from FIG. 8A and the graph showing the relationship between pressure and air permeation rate of FIG. 8B that when the texture is sufficiently wetted, the gaps between fibers in the texture are opened, whereby the air permeability increases to about twice that when the texture is dry.

In addition, the gas permeation mechanism having the textile fabric shape may include a fiber having a polyester component joined to a polyimide component into a side-by-side type. Furthermore, a gas permeation mechanism using fibers formed by twisting the above described fibers can cause three-dimensional structural change when absorbing moisture to thereby further improve the air permeability.

The gas permeation mechanism having a plate shape includes a gas permeation mechanism having a structure including a plate comprised of metal or plastic having an opening portion formed therein and a flap which is comprised of a material that deforms when absorbing moisture and covers the opening portion. When absorbing moisture, the flap deforms, opens the opening portion and increases the air permeability.

The water supply mechanism is provided at a location where produced water in the fuel cell system condenses, specifically, a location thorough which exhaust gas passes and the temperature at which is lower than that of any other location between a fuel cell unit and a discharge port. Such location includes an oxidizer flow path, a radiating portion, a water retaining portion, and a fuel tank surface when accompanied by an endothermic reaction.

Incidentally, the term “oxidizer flow path” herein employed means a flow path through which outside air supplied from an air hole in the fuel cell system flows, and specifically refers to a flow path from the air hole to an oxidizer electrode (cathode) of the fuel cell, a flow path provided in the cathode, and a flow path for discharging the outside air from the cathode.

In contrast to this, the term “fuel path” herein employed means a flow path through which fuel supplied from a fuel container in the fuel cell system flows, and specifically refers to a flow path for leading the fuel from the fuel container to the fuel cell, a flow path for supplying the fuel to an anode in the fuel cell, a flow path provided in the anode, and a flow path from the fuel cell to a discharge mechanism for discharging the fuel in the fuel cell to the outside.

The gas permeation mechanism is dry when the fuel cell has started power generation and therefore provides a small air permeation rate, thereby serving to increase the humidity inside the fuel cell. When the power generation proceeds and water is produced to increase the humidity inside the fuel cell, the water is accumulated at a portion for water collection and is led to the gas permeation mechanism. When the gas permeation mechanism is wetted, the air permeation rate increases, whereby the humidity inside the fuel cell can be reduced. Thereby, it is possible to prevent the power generation characteristics from being degraded due to the blocking of a flow path by produced water.

The gas permeation mechanism having the structure according the present embodiment does not need a sensor or a circuit, but can adjust an air permeation rate so as to optimally keep the humidity inside a cathode. Specifically, in a low humidity state, the gas permeation mechanism can reduce the air permeation rate to increase the humidity inside the fuel cell, thereby preventing an electrolyte membrane from drying. On the other hand, in a high humidity state, the gas permeation mechanism can increases the air permeation rate to vaporize water inside the fuel cell, thereby preventing a flow path from being blocked by water droplets.

### Embodiment 1

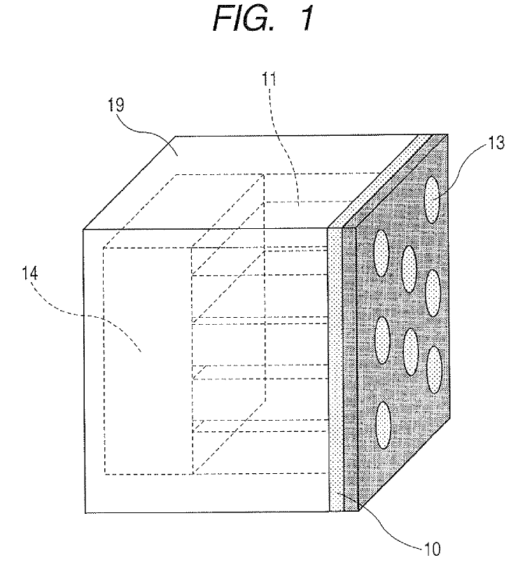

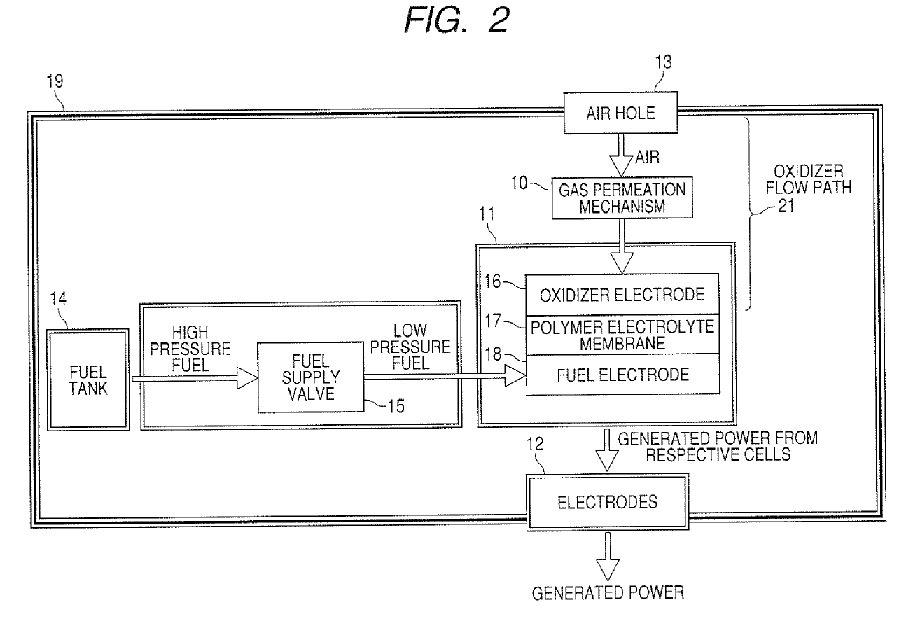

In Embodiment 1, a fuel cell system will be described to which the present invention has been applied. FIG. 1 shows a schematic perspective view illustrating a fuel cell system according to the present embodiment. In addition, FIG. 2 shows a system diagram schematically illustrating a fuel cell system according to the present embodiment. In FIGS. 1 and 2, reference numeral 10 denotes a gas permeation mechanism, reference numeral 11 denotes a fuel cell unit, reference numeral 12 denotes electrodes, reference numeral 13 denotes an air hole, reference numeral 14 denotes a fuel tank, and reference numeral 15 denotes a fuel supply valve. In addition, reference numeral 16 denotes an oxidizer electrode (cathode), reference numeral 17 denotes a polymer electrolyte membrane, reference numeral 18 denotes a fuel electrode (anode), reference numeral 19 denotes a fuel cell casing, and reference numeral 21 denotes an oxidizer flow path.

In the present embodiment, fuel is stored in the fuel tank 14, passes through a fuel path, and is supplied to the anode (fuel electrode) 18 of the fuel cell unit 11. In the fuel path, the fuel supply valve 15 is installed which controls the supply of the fuel to the fuel cell unit 11 from the fuel tank 14. On the other hand, atmospheric air can be taken from the air hole 13 as an oxidizer through natural diffusion. The air taken from the air hole 13 is supplied to the cathode (oxidizer electrode) 16. The generated electric power is supplied to an external device through the electrodes 12. Most of water produced by the reaction is discharged as water vapor to the outside through the air hole 13.

The mass transfer accompanying the power generation in a fuel cell will be described below. For instance, when it is assumed that an electric current generated in a fuel cell with a single fuel cell unit is 1 A, 6.96 cc/min of hydrogen and 3.48 cc/min of oxygen are necessary for the power generation. In addition, 6.96 cc/min (0.00032 mol/min) of water vapor is produced as water. The amount of air for supplying oxygen necessary for the power generation is 16.6 cc/min. On the other hand, the amount of air necessary for discharging the produced water in the form of water vapor greatly varies depending on temperature, but is 301 cc/min at 20° C., 95.6 cc/min at 40° C., and 35.5 cc/min at 60° C. Accordingly, when discharging the produced water only in the form of water vapor, the fuel cell needs more air for discharging the produced water than that for supplying oxygen. The amount of the air necessary for discharging the water varies depending on the temperature. When the fuel cell unit 11 has a stacked structure (stack) including a plurality of fuel cell units so as to obtain more generated power, the amounts of hydrogen and oxygen necessary for power generation per unit electric current and the amount of water to be discharged are multiplied by the number of the stacking.

In the present embodiment, a gas permeation mechanism 10 which varies the air permeation rate in response to water content is provided in an oxidizer flow path 21 (between an oxidizer electrode 16 and an air hole 13 of a casing 19). A member which varies the air permeation rate in response to the water content includes a fiber type and a plate type having the air hole. The fiber type of a member includes, for instance, a textile fabric including a material extending when absorbing moisture, such as a polyether ester, and a non-extending material such as a polyester. Another usable member is a fiber made by joining a polyester component to a polyimide component side by side. Furthermore, the member using the fiber formed by twisting the above described fibers can cause three-dimensional structural change when absorbing moisture to further improve the air permeability.

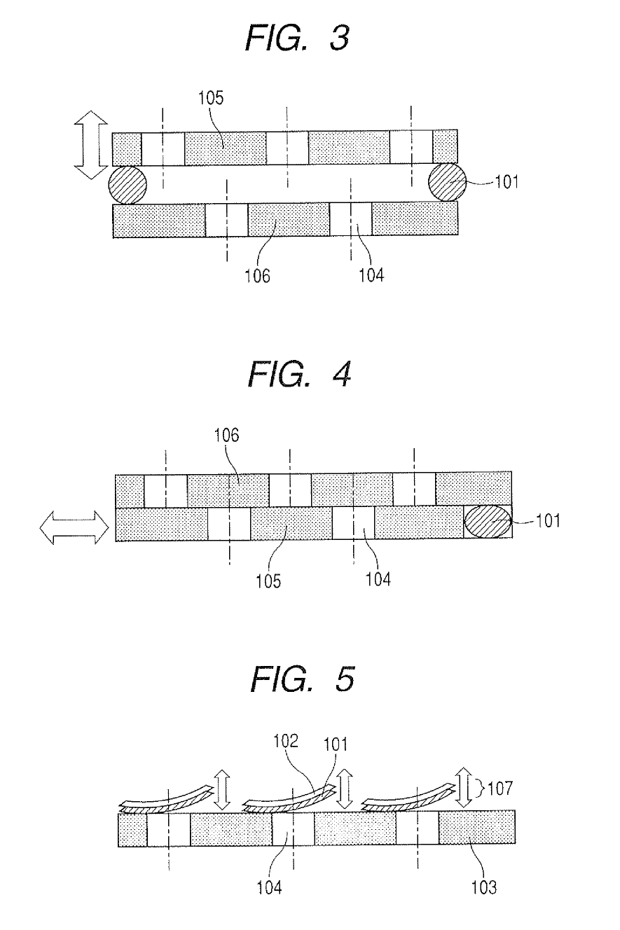

As a structural example of the gas permeation mechanism according to the present embodiment, a first form shown in FIG. 3 or a second form shown in FIG. 4 can be adopted. The first form shown in FIG. 3 has a structure in which a hygroscopic expansion member 101 is interposed between two plates 105 and 106 having air holes. One of the two plates is fixed and the other can be displaced. The air holes of the two plates are disposed in a staggered form. When the hygroscopic expansion member 101 absorbs water, it expands to widen the spacing between the two ventilation plates, and increases the air permeability of the gas permeation mechanism.

On the other hand, in the second form shown in FIG. 4, two plates 105 and 106 having air holes therein are superimposed on each other such that the air holes are positioned in a staggered form. One of the two plates is fixed and the other can be displaced. The movable ventilation plate 105 is adjacent to the hygroscopic expansion member 101. When the hygroscopic expansion member 101 absorbs water, it expands, displaces the movable vent plate 105, and increases an overlapping area of the air holes of the two plates, thereby increasing the air permeation rate.

As the material of the hygroscopic expansion member 101, there can be used polyacrylamide gel, a rubber material which expands when absorbing moisture.

The ventilation plate can be produced by etching, cutting or pressing a metal body such as of stainless steel or aluminum, or may be produced by injection molding a plastic material.

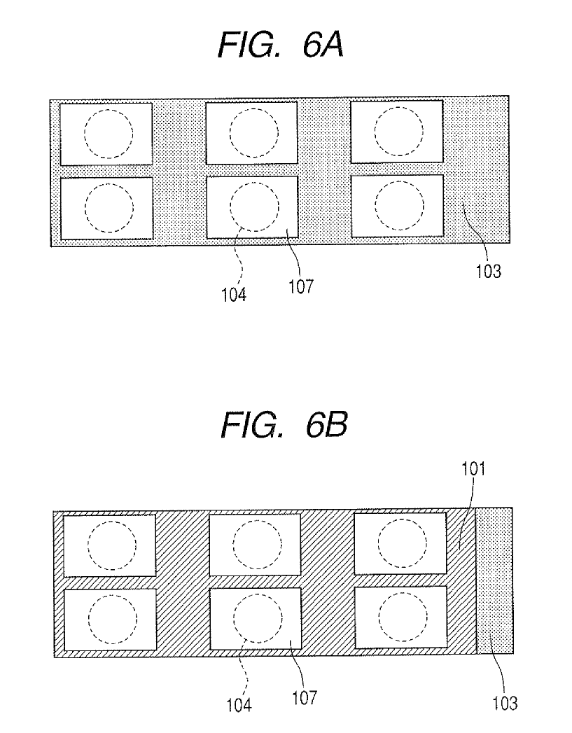

Furthermore, the gas permeation mechanism can have a third form shown in a schematic cross-sectional view of FIG. 5, as another structural example. FIGS. 6A and 6B are schematic plan views of the third form shown in FIG. 5. Flaps 107 each comprised of a hygroscopic expansion member 101 and a non-hygroscopic/expansion member 102 are prepared on the surface of a substrate 103 having air holes. As the material for the non-hygroscopic/expansion member 102, there can be included a material which has no hygroscopicity or a material which does not expand even when absorbing moisture, for example, a metal thin film and a plastic thin film. When the flap 107 absorbs water, the flap is warped by a stress which has been produced therein due to a difference in expansion coefficient between the both members. Thereby, the area of the air hole changes to change the air permeation rate. The substrate 103 having air holes can be produced by etching, cutting, or pressing a metal body such as of stainless steel or aluminum, or may be produced by injection molding a plastic material. When the substrate 103 is produced, in particular, by patterning a semiconductor substrate such as a silicon substrate by using photolithography technique and anisotropically wet etching the semiconductor substrate or etching the semiconductor substrate by using an ICP-RIE (reactive ion etching) technique, the substrate can be reduced in size.

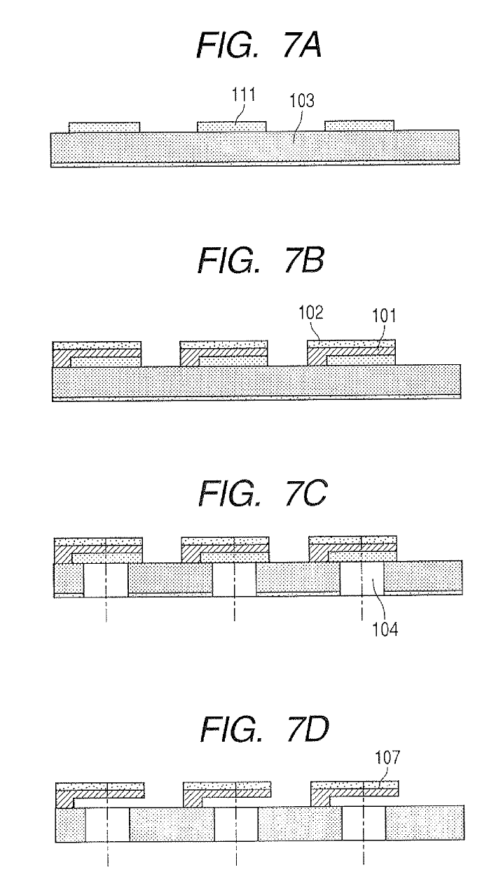

In the next place, a production process of preparing a gas permeation mechanism of the above described third form by using the photolithography technique will be described with reference to FIGS. 7A, 7B, 7C and 7D. The first step illustrated in FIG. 7A is a step of patterning a sacrificial layer 111 on a substrate 103 made of a silicon wafer. The silicon wafer to be used has both surfaces polished and has a thickness of about 300 μm. At first, the silicon wafer is thermally oxidized to form a silicon oxide layer of about 1 μm in thickness on the surface. Subsequently, the rear surface is protected with a photoresist, and the oxide layer on the surface is removed in an etching step by use of hydrofluoric acid. Then, an aluminum film is formed on the surface by a vacuum deposition technique, is patterned by using the photolithography technique, and is etched.

The second step illustrated in FIG. 7B is a step of forming films of a hygroscopic expansion member 101 and a non-hygroscopic/expansion member 102, and patterning them. For the hygroscopic expansion member, cellulose or the like can be sued, and for the non-hygroscopic/expansion member 102, an organic material such as polyimide and various metal thin films can be used. At first, cellulose is spin-coated, followed by drying, and polyimide is spin-coated thereon. The film is patterned by using the photolithography technique, and is etched by plasma. In this case, there may alternatively be adopted a process in which after a thick photoresist is patterned, films of the hygroscopic expansion member 101 and the non-hygroscopic/expansion member 102 are formed, and unnecessary portions are removed by a lift-off technique.

The third step illustrated in FIG. 7C is a step of preparing air holes 104. The silicon oxide layer on the rear surface is patterned by using a photolithography technique, and is etched by using hydrofluoric acid. Then, the silicon substrate is perpendicularly etched with an ICP-RIE (reactive ion etching). As the etching method, an anisotropic wet etching technique may be employed which uses KOH and TMAH (aqueous solution of tetramethylammonium hydroxide).

The fourth step illustrated in FIG. 7D is a step for removing a sacrificial layer 111. The silicon oxide layer on the rear surface is removed by hydrofluoric acid, and then the sacrificial layer 111 is further etched by hydrochloric acid or the like. The sacrificial layer 111 is removed by side etching, which releases a flap 107 from a substrate 103. By the above described steps, the gas permeation mechanism illustrated in FIGS. 5, 6A and 6B is completed.

If the hygroscopic expansion member 101 is patterned so as to connect the respective flaps to one another as illustrated in FIG. 6B, when a part of the hygroscopic expansion member 101 is wetted, water immediately diffuses in the hygroscopic expansion member 101. Accordingly, all the flaps can be driven approximately simultaneously, so that the air permeation rate can be changed remarkably with a small amount of water.

On the other hand, if the hygroscopic expansion member 101 is patterned so as not to connect the respective flaps as shown in FIG. 6A, each flap 107 independently operates. Accordingly, for instance, when only some fuel cell units of a fuel cell stack contain excessive water, the air permeability of only the fuel cell units containing the excessive water can be increased without affecting the other fuel cell units. FIG. 8B illustrates the characteristics of air flow rate when the gas permeation mechanism is in a dry state (25° C., 50% RH) and in a wet state, which is made of a textile fabric including a polyether ester and a polyester. The ventilation area is 20 mm×20 mm. When a membrane is wetted, the air permeation rate increases to twice that when the membrane is dry.

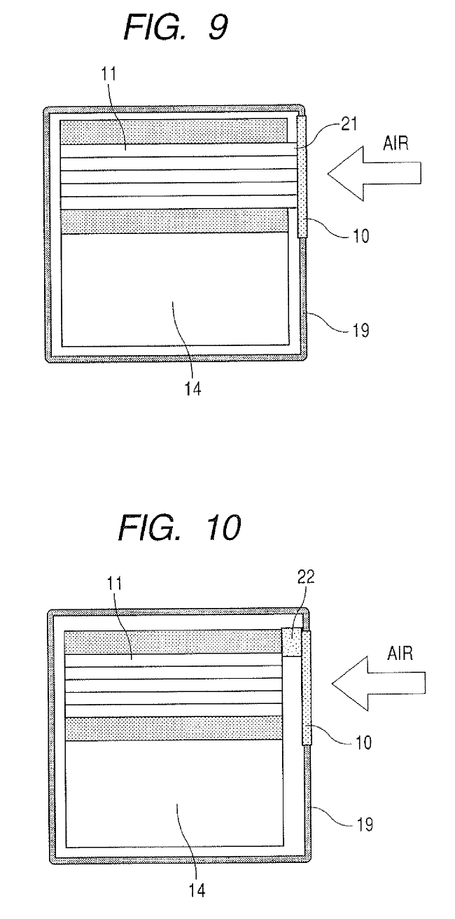

The thus produced gas permeation mechanism is placed in a fuel cell. In the present embodiment, the gas permeation mechanism 10 is provided between an air inlet and an oxidizer flow path 21 so as to be in contact with the oxidizer flow path, as is illustrated in FIG. 9. In this case, use of a metal foam body for the oxidizer flow path makes it possible to efficiently intake outside air and to electrically connect stacks to each other efficiently. Water produced by power generation forms dew (causes dew condensation) in the oxidizer flow path. The condensed water is led to the gas permeation mechanism via the oxidizer flow path. Particularly, the water moves to the gas permeation mechanism by a capillary action. When the gas permeation mechanism is wetted, the air permeation rate increases, which facilitates water in the oxidizer flow path to be evaporated, whereby flooding phenomenon can be suppressed.

Further, when an oxidizer flow path 21 and a gas permeation mechanism 10 cannot be disposed in contact with each other, a water flow path 22 may be provided therebetween as illustrated in FIG. 10. By using a member comprised of urethane foam or polyacrylamide for the water flow path, water can be transported from the oxidizer flow path 21 to the gas permeation mechanism 10 through a capillary action. In addition, when the gas permeation mechanism 10 is provided at a lower position in a gravitational direction than a fuel cell unit and a fuel path, because water droplets easily move downward by the gravity, the produced water can more efficiently be led to the gas permeation mechanism 10. On the other hand, when the gas permeation mechanism 10 is provided at an upper position in a gravitational direction than the fuel cell unit and the fuel path, because a force of moving the produced water downward by gravity and a force of sucking the produced water upward by a capillarity action of the gas permeation mechanism counterbalance each other, the water distribution in the fuel cell can be kept uniform. Accordingly, it is effective to provided the gas permeation mechanism at a lower position when the system is desired to be used in a more dried environment, and to provide the gas permeation mechanism in an upper position when the system is desired to be used in a more wetted environment, depending on the wettability of a member which constitutes the fuel cell unit (polymer electrolyte membrane and gas diffusion member). For instance, when a textile fabric composed of a polyether ester and a polyester is used as the gas permeation mechanism, the air permeation rate can be increased by being wetted to about twice that in a dry state. Thereby, the operable output range of the fuel cell can be widened, and the fuel cell can be driven stably for a longer period of time.

### Embodiment 2

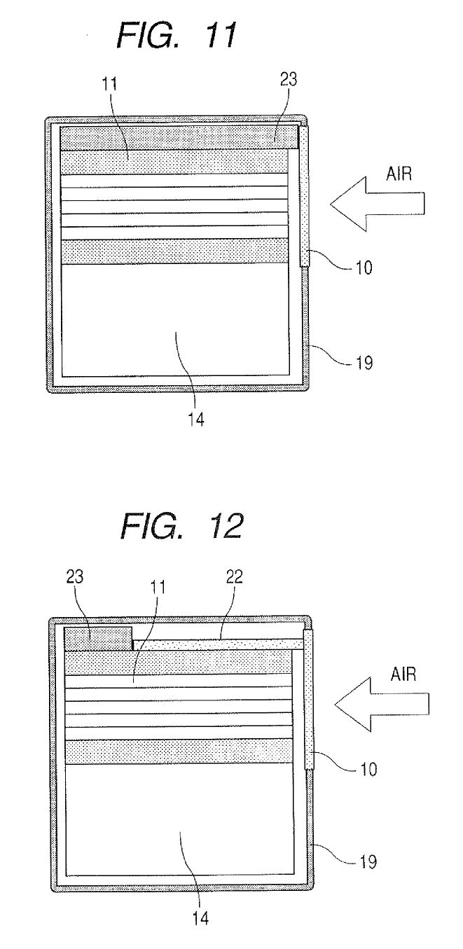

In Embodiment 2, a structural example will be described which has a water retaining portion provided therein. FIG. 11 is a schematic cross-sectional view illustrating the structural example according to the present embodiment. In FIG. 11, the elements which are the same as those described in Embodiment 1 are identified by like numerals, so that description of common elements will be omitted. In FIG. 11, reference numeral 23 denotes a water retaining portion. A fuel cell of the present embodiment has the same structure as that of Embodiment 1 as to the gas permeation mechanism, but has a different structure from that in Embodiment 1 in having the water-retaining portion 23 for retaining produced water and humidifying an electrolyte membrane. For the water retaining portion, there may be used a hygroscopic material such as a polyacrylamide gel, sponge-shaped polyvinyl alcohol, and cellulose.

In the present embodiment, the gas permeation mechanism 10 is provided to an oxidizer flow path 21, in contact with the water retaining portion 23, as shown in FIG. 11. Water produced by power generation is stored in the water retaining portion. A part of the stored water is led to the gas permeation mechanism. When the gas permeation mechanism is wetted, the air permeation rate increases, which facilitates water in the oxidizer flow path to be evaporated, whereby a flooding phenomenon can be suppressed. Particularly, because the gas permeation mechanism 10 has a moisture absorbing portion, the gas permeation mechanism 10 can function also as a water retaining portion of the fuel cell.

Further, when a water retaining portion 23 and a gas permeation mechanism 10 cannot be disposed in contact with each other, a water flow path 22 may be provided therebetween as illustrated in FIG. 12. By using a member comprised of urethane foam or polyacrylamide for the water flow path, water can be transported from the water retaining portion 23 to the gas permeation mechanism 10 through a capillary action.

### Embodiment 3

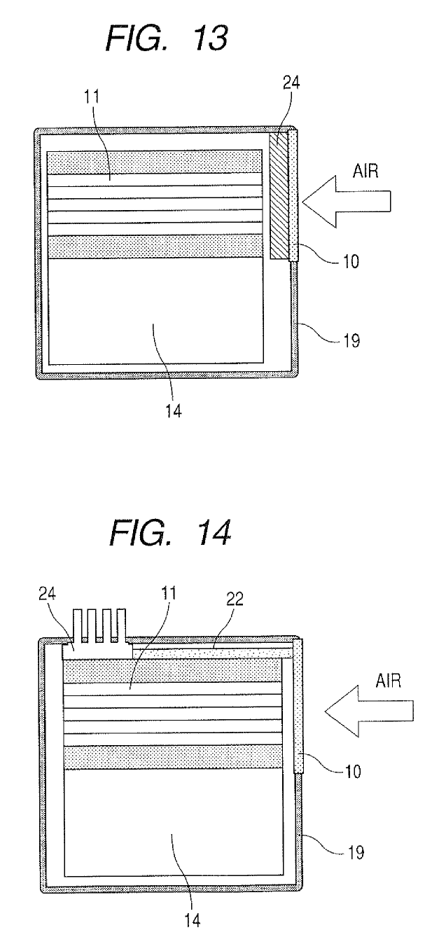

In Embodiment 3, a structural example will be described which has a radiating portion provided therein. FIG. 13 is a schematic cross-sectional view illustrating the structural example according to the present embodiment. In FIG. 13, the elements which are the same as those described in the above embodiments are identified by like numerals, so that description of common elements will be omitted. In FIG. 13, reference numeral 24 denotes a radiating portion. A fuel cell of the present embodiment has the same structure as that of Embodiment 1 as to the gas permeation mechanism, but has a different structure from that in Embodiment 1 in having the radiating portion 24 for radiating heat generated by power generation. The radiating portion is comprised of a high thermal conductivity material such as metal and carbon, and when higher radiation efficiency is required, the radiating portion 24 may be formed into a fin shape or may be cooled with a fan.

In the present embodiment, the gas permeation mechanism 10 is provided to an oxidizer flow path 21, in contact with the radiating portion 24, as shown in FIG. 13. The radiating portion 24 is cooled by outside air and has a lower temperature than that at the other parts in a fuel cell system. Accordingly, water produced by power generation tends to form dew (cause dew condensation) at the radiating portion. The condensed water is led to the gas permeation mechanism 10. When the gas permeation mechanism 10 is wetted, the air permeation rate increases, which facilitates water in the oxidizer flow path to be evaporated, whereby a flooding phenomenon can be suppressed. Particularly, when a metal material is used for a member having air holes of the gas permeation mechanism 10, the gas permeation mechanism 10 can be used as a radiating member, can efficiently radiate heat generated by the power generation of the fuel cell, and simultaneously can control the air permeation rate. In addition, the radiating portion can utilize, for heat radiation, latent heat resulting from the evaporation of water through the gas permeation mechanism to further increase the radiation efficiency. At the same time, the radiating portion makes the water collected in the gas permeation mechanism to be evaporated more easily, and can effectively vaporize surplus water.

Further, when a heat radiating portion 24 and a gas permeation mechanism 10 cannot be disposed in contact with each other, a water flow path 22 may be provided therebetween as illustrated in FIG. 14. By using a member comprised of urethane foam or polyacrylamide for the water flow path, water can be transported from the radiating portion 24 to the gas permeation mechanism 10 through a capillary action.

### Embodiment 4

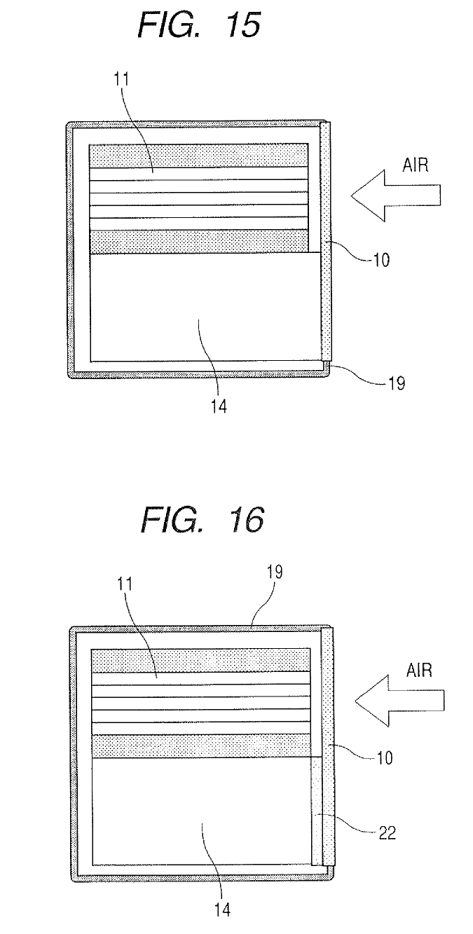

In Embodiment 4, a structural example will be described which has a fuel tank filled with a hydrogen storage alloy. FIG. 15 is a schematic cross-sectional view illustrating the structural example according to the present embodiment. In FIG. 15, the elements which are the same as those described in the above embodiments are identified by like numerals, so that description of common elements will be omitted. A fuel cell of the present embodiment has the same structure as that of Embodiment 1 as to the gas permeation mechanism, but has a different structure from that in Embodiment 1 in having a fuel tank filled with a hydrogen storage alloy. As the hydrogen storage alloy, LaNi₅ can be used, for instance.

In the present embodiment, the gas permeation mechanism 10 is provided to an oxidizer flow path 21, in contact with the fuel tank 14, as shown in FIG. 15. The hydrogen storage alloy releases hydrogen according to an endothermic reaction, so that the temperature of the fuel tank 14 decreases along with hydrogen consumption. For instance, LaNi₅ absorbs heat of about 30 kJ per mole of hydrogen. At this time, the temperature of the tank surface decreases by about 10° C. Accordingly, water produced by power generation easily forms dew (causes dew condensation) on the surface of the fuel tank 14. The condensed water is led to the gas permeation mechanism. When the gas permeation mechanism 10 is wetted, the air permeation rate increases, which facilitates water in the oxidizer flow path to be evaporated, whereby a flooding phenomenon can be suppressed.

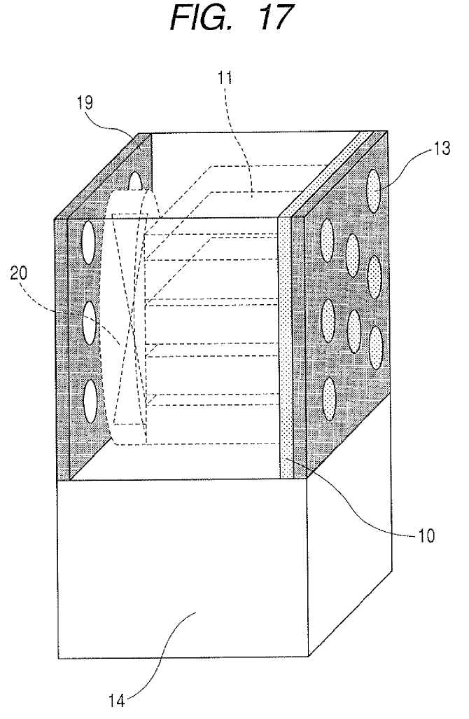

Further, when a fuel tank 14 and a gas permeation mechanism 10 cannot be disposed in contact with each other, a water flow path 22 may be provided therebetween as illustrated in FIG. 16. By using a member comprised of urethane foam or polyacrylamide for the water flow path, water can be transported from the fuel tank 14 to the gas permeation mechanism 10 through a capillary action.

### Embodiment 5

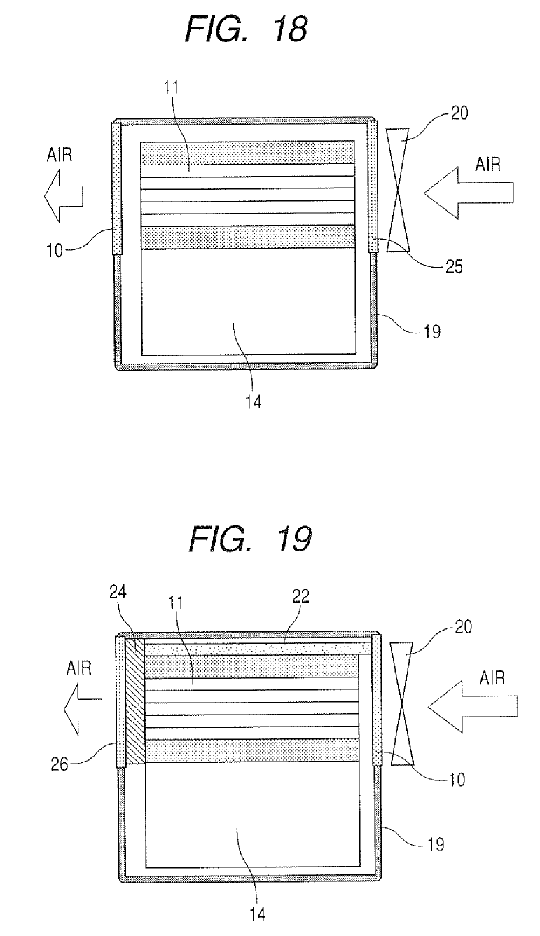

In Embodiment 5, a structural example will be described which employs a fan for air intake. FIG. 17 is a schematic cross-sectional view illustrating the structural example according to the present embodiment. In FIG. 17, the elements which are the same as those described in the above embodiments are identified by like numerals, so that description of common elements will be omitted. In FIG. 17, reference numeral 20 denotes a fan. A fuel cell of the present embodiment has the same structure as that of Embodiment 1 as to the gas permeation mechanism, but has a different structure from that in Embodiment 1 in having the fan 20 for radiating heat generated accompanying power generation. Because of using the fan 20, the fuel cell can take in a larger amount of air than by natural diffusion as in Embodiment 1, and consequently increase a generated electric current. The fuel cell in the present embodiment has an inlet for taking air into the fuel cell by the fan 20 and a discharge port for discharging excessive air together with water vapor.

Alternatively, in the present embodiment, as shown in FIG. 18, an upstream air hole 25 is provided at an air inlet and a gas permeation mechanism 10 according to the present invention is provided at the discharge port. Air forced by the fan 20 is controlled by the gas permeation mechanism 10 to adjust the flow rate. When water is produced accompanying power generation in the fuel cell, wet air (and fine water droplets) passes through the gas permeation mechanism 10. When the gas permeation mechanism 10 is wetted by the wet air, the air permeation rate increases, which facilitates water in the oxidizer flow path to be evaporated, whereby a flooding phenomenon can be suppressed. Furthermore, water on the gas permeation mechanism is also evaporated by the passing air. Particularly, as described in Embodiments 1, 2, 3, and 4, by disposing the gas permeation mechanism in contact with a member which can easily collect the water in the fuel cell, the gas permeation mechanism 10 works more effectively. For instance, a textile fabric made of a polyether ester and a polyester can be used for the gas permeation mechanism. When a small DC fan is used as the above-mentioned fan and the ventilation area is set to 1 cm by 1 cm, the air permeation rate, which is 190 cc/min in a dry state, increases to 385 cc/min in a wet state. Thereby, the operable output range of the fuel cell can be widened, and the fuel cell can be stably driven for a longer period of time.

### Embodiment 6

Embodiment 6 of the present invention will be described. FIG. 19 is a schematic cross-sectional view illustrating the structural example according to the present embodiment. In FIG. 19, the elements which are the same as those described in the above embodiments are identified by like numerals, so that description of common elements will be omitted. In FIG. 19, reference numeral 20 denotes a fan. A fuel cell of the present embodiment has the same structure as that of Embodiment 1 as to the gas permeation mechanism. In FIG. 19, reference numeral 26 denotes a downstream air hole. A gas permeation mechanism used in the present embodiment has the same structure as with Embodiment 1. In the fuel cell system according to the present embodiment, a fan 20 is used for air intake as with Embodiment 5. In the present embodiment, the gas permeation mechanism 10 according to the present invention is provided at an air inlet and a downstream air hole 26 is provided at a discharge port. In this case, in order to wet the gas permeation mechanism with produced water in a fuel cell, for instance, as shown in FIG. 19, by providing a radiating portion 24 on a downstream side of a fuel cell unit in an oxidizer flow path, the produced water is allowed to form dew (cause dew condensation), and the condensed water is led to the gas permeation mechanism 10 through a water flow path 22. The radiating portion 24 and the water flow path 22 have the same structures as with Embodiment 3. By adopting this structure, the water which has been produced in the fuel cell units and condensed on a downstream radiating plate is allowed to pass through the water flow path to wet the gas permeation mechanism 10, thereby controlling the air permeation rate. Furthermore, the fuel cell units can be humidified with the water collected in the gas permeation mechanism. In addition, by providing a water-retaining portion in place of a radiating portion as with Embodiment 2, or by disposing the radiating portion or the water retaining portion in contact with the oxidizer flow path as with Embodiment 1, the produced water can efficiently be collected.

### Embodiment 7

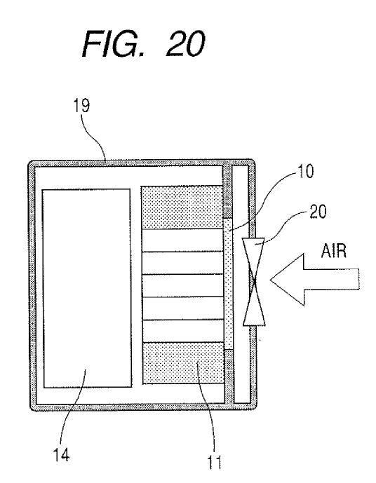

Embodiment 7 of the present invention will be described. FIG. 20 is a schematic cross-sectional view illustrating the structural example according to the present embodiment. In FIG. 20, the elements which are the same as those described in the above embodiments are identified by like numerals, so that description of common elements will be omitted. A gas permeation mechanism used in the present embodiment has the same structure as that of Embodiment 1. A fan 20 is used for air intake as with Embodiment 5, but an opening is provided which serves both as an air inlet and as a discharge port, and a gas permeation mechanism 10 is provided. Air taken in through the gas permeation mechanism 10 is supplied to fuel cell units 11, then collides with an inner wall in a casing to change the moving direction thereof, passes through the gas permeation mechanism 10 again to be discharged. In this case, the gas permeation mechanism 10 is wetted by the discharged air to control the air permeation rate, and at the same time, water on the gas permeation mechanism 10 is also evaporated. Furthermore, the taken-in air is humidified when passing through the gas permeation mechanism 10, by the water on the gas permeation mechanism 10. Particularly, as described in Embodiments 1, 2, 3, and 4, by disposing the gas permeation mechanism in contact with a member which can easily collect the water in the fuel cell, the gas permeation mechanism 10 works more effectively.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-238996, filed Sep. 4, 2006, which is hereby incorporated by reference herein in its entirety.

What is claimed is:

1. A fuel cell system which generates an electric power by supplying fuel to a fuel electrode while supplying outside air to an oxidizer electrode through an air hole, comprising:
a gas permeation mechanism that comprises a member which has air permeability increased when absorbing moisture than when being dry, in a flow path through which the outside air supplied from the air hole flows.

2. The fuel cell system according to claim 1, wherein the gas permeation mechanism has a structure comprising a plurality of segments and the respective segments operate independently of one another depending on dry/wet condition.

3. The fuel cell system according to claim 1, wherein the member having increasable air permeability comprises a fixed member having the air hole, a movable member having the air hole, and a hygroscopic swelling material, and wherein the movable member having the air hole moves by deformation of the hygroscopic swelling material due to moisture absorption to adjust an air permeation rate.

4. The fuel cell system according to claim 1, wherein the member having increasable air permeability comprises a substrate having the air hole, and a deformable portion comprising a hygroscopic expansion member and a non-hygroscopic/expansion member provided at the air hole of the substrate, and wherein the deformable portion is deformed due to a difference in expansion amount when absorbing moisture to adjust an air permeation rate.

5. The fuel cell system according to claim 4, wherein the hygroscopic expansion member is provided in a flow path through which the outside air flows so as to face in a direction in which water is supplied to the gas permeation mechanism.

6. The fuel cell system according to claim 4, wherein the gas permeation mechanism comprises a semiconductor substrate in at least a part thereof.

7. The fuel cell system according to claim 1, wherein the member having increasable air permeability comprises a textile fabric.

8. The fuel cell system according to claim 7, wherein the textile fabric comprises a hygroscopic self-expanding yarn and a non-self-extending yarn.

9. The fuel cell system according to claim 7, wherein the textile fabric comprises a crimped fiber having a percentage of crimp reduced when wetted, and a non-crimped fiber or a crimped fiber having a crimp substantially unchanged when wetted.

10. The fuel cell system according to claim 7, wherein the textile fabric comprises a synthetic fiber having a hygroscopic polymer twisted therewith.

11. The fuel cell system according to claim 1, further comprising a water supply mechanism for supplying water produced by the power generation to the gas permeation mechanism.

12. The fuel cell system according to claim 1, further comprising a radiating portion for radiating heat generated accompanying the power generation, wherein the gas permeation mechanism is provided adjacent to the radiating portion or is connected to the radiating portion through a water flow path.

13. The fuel cell system according to claim 1, further comprising a fuel tank for supplying the fuel to the fuel electrode while accompanied by an endothermic reaction, wherein the gas permeation mechanism is provided adjacent to the fuel tank or is connected to the fuel tank through a water flow path.

14. The fuel cell system according to claim 1, wherein the gas permeation mechanism is provided in an oxidizer flow path between the air hole for supplying the outside air to the oxidizer electrode and the oxidizer electrode.

15. The fuel cell system according to claim 1, wherein the outside air is supplied by a fan or compressor.

16. The fuel cell system according to claim 15, wherein the gas permeation mechanism is provided downstream of a power generation cell unit constituting the fuel cell in a flow of the outside air forced by the fan or compressor.

17. The fuel cell system according to claim 15, wherein the gas permeation mechanism is provided upstream of a power generation cell unit of the fuel cell in a flow of the outside air forced by the fan or compressor, a radiating portion is provided downstream of the power generation cell unit of the fuel cell in the flow, and the gas permeation mechanism and the radiating portion are connected through a water flow path.

18. The fuel cell system according to claim 15, further comprising an air hole which serves both as a supply port for supplying the outside air and a discharge port for discharging the air, wherein the gas permeation mechanism is provided between the air hole and a power generation cell unit constituting the fuel cell.
